(19) United States
(12) Patent Application Publication
(10) Pub. No.: US 2006/0101880 A1
(43) Pub. Date: May 18, 2006

(54) Re-keyable lock cylinder

(76) Inventors: Paul C. Ward-Dolkas, Palo Alto, CA (US); William R. Knapp, Salinas, CA (US)

Correspondence Address: THE BLACK & DECKER CORPORATION, 701 EAST JOPPA ROAD, TW199, TOWSON, MD, 21286, US

(21) Appl. No.: 10/987,708

(22) Filed: Nov. 12, 2004

(51) Int. Cl. E05B 29/04

(52) U.S. Cl. 70/492; 70/383; 70/384

(57) ABSTRACT

A wafer-type lockset that employs wafer assemblies and locking keys to adjustably key the lockset. The wafer assemblies include a base wafer and a re-settable wafer that may be adjustably coupled to the base wafer. The locking keys are movable between a first position, in which the base and re-settable wafers are coupled to one another, and a second position, in which the base and re-settable wafers are uncoupled from one another. A key having a desired key profile may be employed to set or program the lockset. A method for re-keying a lockset is also provided.

The present invention generally relates to lock cylinders and more particularly to lock cylinders that can be re-keyed without the use of a master key.

When re-keying a cylinder using a traditional wafer lock design, the user is required to remove the cylinder plug from the cylinder body and replace the appropriate wafers so that a new key can be used to operate the lockset. This typically requires the user to remove the cylinder mechanism from the lockset and then disassemble the cylinder to some degree to remove the plug and replace the wafers as necessary. This requires a working knowledge of the lockset and cylinder mechanism and is usually only performed by locksmiths or trained professionals. Additionally, the process usually employs special tools and requires the user to have access to wafer replacement kits to interchange wafers and replace components that can get lost or damaged in the re-keying process.

### SUMMARY

In one form, the present teachings provide a lockset with a lock cylinder body and a plug assembly. The lock cylinder body includes a wall member, which defines an interior cavity, and first and second grooves that formed on an interior surface of the wall member. The plug assembly has a keyway that is disposed about a longitudinal axis of the plug assembly. The plug assembly may include a plug, a plurality of wafer slots, a plurality of locking keys and at least one locking bar. The plug may have a plurality of wafer slots, a locking key recess and a locking bar recess. The locking key recess and the locking bar recess extend generally parallel to the longitudinal axis. The locking key recess intersects the wafer slots and the locking bar recess. Each wafer assembly is disposed in a wafer slot and includes a base wafer and a re-settable wafer. Each wafer assembly is movable in an associated wafer slot between a first position, wherein the wafer assembly extends outwardly from the plug into an associated one of the first and second grooves, and a second position, wherein the wafer assembly is substantially retracted into the plug so as to permit the plug to be rotated relative to the lock cylinder body. The locking keys are disposed in the locking key recess and are movable between a first position and a second position. Placement of the locking keys in the first position couples each base wafer to an associated re-settable wafer so that movement of one of the base wafer and its associated re-settable wafer in a respective wafer slot in a direction that is generally perpendicular to the longitudinal axis effects corresponding movement of the other one of the base wafer and its associated re-settable wafer. Placement of the locking keys in the second position retracts the locking keys from the re-settable wafers so as to permit relative movement that is generally perpendicular to the longitudinal axis between the re-settable wafers and the base wafers. The locking bar is removably disposed in the locking bar recess. Placement of the locking bar in the locking bar recess inhibits movement of the locking keys from the first position to the second position

In another form, the present teachings provide a method for re-keying a lockset that includes: providing a lockset having a lock cylinder body and a plug assembly, the plug assembly including a plug body, a plurality of wafer assemblies, a plurality of locking keys, each of the wafer assemblies including a base wafer and a re-settable wafer, each locking key being engaged with an associated wafer assembly to thereby couple the base wafer and the re-settable wafer of each wafer assembly to one another; inserting a key with a desired key profile into the plug assembly; disengaging each of the locking keys from an associated re-settable wafer to permit relative movement between each base wafer and its associated re-settable wafer such that at least one of the base wafer and the re-settable wafer contacts the desired key profile; and re-engaging each of the locking keys to their associated re-settable wafer to inhibit relative movement between the base wafers and the re-settable wafers; wherein the key is not employed to disengage the locking keys from the associated re-settable wafers.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is an exploded perspective view of a re-keyable lock cylinder constructed in accordance with the teachings of the present invention;

FIG. 2 is a partial section view of the re-keyable lock cylinder of FIG. 1 taken in a direction that is generally transverse to the longitudinal axis of the re-keyable lock cylinder;

FIG. 3 is a perspective view of a portion of the re-keyable lock cylinder of FIG. 1 illustrating the construction of the wafer assemblies and locking keys in greater detail; and

FIG. 4 is a partial section view similar to that of FIG. 2 but illustrating a key installed to the re-keyable lock cylinder and the locking keys disengaged from the re-settable wafers.

### DETAILED DESCRIPTION OF THE VARIOUS EMBODIMENTS

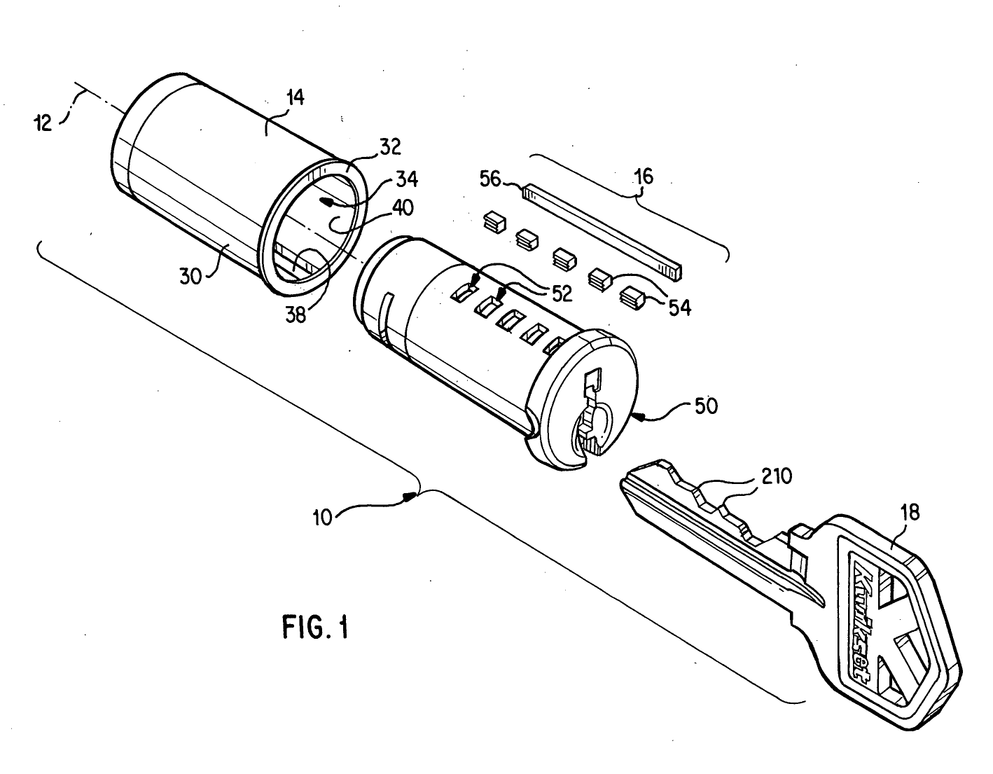

With reference to FIG. 1 of the drawings, a lock cylinder constructed in accordance with the teachings of the present invention is generally indicated by reference numeral 10. The lock cylinder 10 is illustrated to be a wafer-type lock mechanism that utilizes single-sided wafers, but those skilled in the art will appreciate that the teachings of the present invention have applicability to other types of lock mechanisms, including wafer-type lock mechanisms utilizing double-sided wafers.

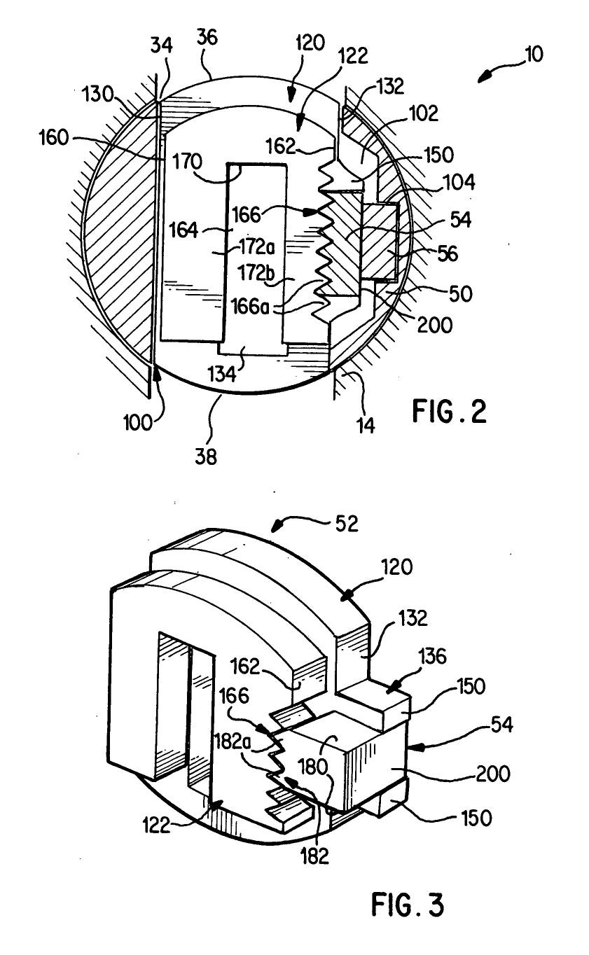

The lock cylinder 10 is disposed about a longitudinal axis 12 and may include a lock cylinder body 14, a plug assembly 16 and a “matched” key 18. With additional reference to FIG. 2, the lock cylinder body 14 may include a generally cylindrical body portion 30 with a wall member 32 that defines an interior cavity 34. First and second grooves 36 and 38, respectively, are formed in the interior surface 40 of the wall member 32.

Returning to FIG. 1, the plug assembly 16 may include a plug 50, a plurality of wafer assemblies 52, one or more locking keys 54, and one or more locking bars 56. With additional reference to FIG. 2, the plug 50 may have a generally cylindrical outer shape and may include one or more wafer slots 100, a locking key recess 102 and a locking bar recess 104. The wafer slots 100, which are sized to receive therein the wafer assemblies 52, may extend through the plug 50 in a direction that is generally transverse to the longitudinal axis of the plug 50. The locking key recess 102 extends longitudinally along the plug 50 and intersects the wafer slots 100. The locking bar recess 104, which also extends longitudinally along the plug 50, may be disposed on a side of the locking key recess 102 opposite the locking key recess 102 such that the locking bar recess 104 and the locking key recess 102 are contiguous.

With reference to FIGS. 2 and 3, each wafer assembly 52 may include a base wafer 120 and a re-settable wafer 122. The base wafer 120 includes opposing side edges 130 and 132, a central opening 134, and an attachment portion 136. The base wafer 120 may be sized to be slidably received in an associated one of the wafer slots 100 and to be movable between a disengaged position, wherein the base wafer 120 is positioned within a cylindrical envelope that may be defined by the plug 50 so that the plug 50 is rotatable in the interior cavity 34 of the lock cylinder body 14, and an engaged position, wherein the base wafer 120 extends from the outwardly from the wafer slot 100 into one of the first and second grooves 36, 38 to thereby inhibit rotation between the plug 50 and the lock cylinder body 14. The central opening 134 may be sized to receive a key having a bitting (i.e., profile height) that corresponds to a maximum permissible biting for the key 18 (FIG. 1). In some instances, the maximum biting may correspond to the profile height of an uncut (i.e., blank) key of the type from which the key 18 is cut. The attachment portion 136 may be configured to capture an associated one of the locking keys 54. In the particular example provided, the attachment portion 136 includes a pair of spaced apart arms 150 that extend from the side edge 132 and between which the locking key 54 may be received. A spring (not shown), such as a conventional compression spring, may be disposed between the arms 150 to exert a force on the side edge 132 and the locking key 54 that biases the locking key 54 away from the side edge 132 into the recess 104. Other re-keyable lock cylinders constructed in accordance with the teachings of the present invention may bias the locking key 54 through other means, such as a magnet (not shown). A spring (not shown), such as a compression spring, may be disposed in the locking key recess 102 between one of the arms 150 and the plug 50 to bias the base wafer 120 in a predetermined direction so that it extends outwardly of the plug 50 into an associated one of the first and second grooves 36, 38.

The re-settable wafer 122 may include opposing side edges 160 and 162, a central opening 164, and a first engagement portion 166. In the example provided, the re-settable wafer 122 is generally U-shaped, being sized to fit within an associated wafer slot 100 and having a key engaging portion 170 that is disposed between a pair of legs 172a and 172b, the inner edges of which collectively define the central opening 164. The first engagement portion 166 is configured to cooperate with the locking key 54 to permit the re-settable wafer 122 to be adjustably positioned in a direction that is generally transverse to the longitudinal axis of the plug 50. In the particular example provided, the first engagement portion 166 includes a plurality of teeth 166a that are formed along the outer edge of the leg 172b of the re-settable wafer 122.

Each locking key 54 is disposed in the locking key recess 102 and is employed to fixedly but removably secure one of the base wafers 120 with an associated one of the re-settable wafers 122. In the example provided, each locking key 54 is a bar-like member having end surfaces 180 and a second engagement portion 182. The end surfaces 180 are “vertically” captured by and “horizontally” slidable on the arms 150. The second engagement portion 182 may be engaged to the first engagement portion 166 to thereby fixedly but removably secure the locking key 54 to the re-settable wafer 122. As the locking key 54 is captured between the arms 150 of the base wafer 120, movement of the either of the base wafer 120 and the re-settable wafer 122 along a vertical axis effects an identical movement of the other since both the base wafer 120 and the re-settable wafer 122 are locked together.

In the embodiment illustrated, the second engagement portion 182 includes one or more teeth 182a that are configured to meshingly engage the teeth 166a of the first engagement portion 166. The teeth 166a and 182a are illustrated as being generally V-shaped and oriented generally transverse to the longitudinal axis of the plug 50. In the particular example provided, the profile of the teeth 166a and 182a permits the upward motion of the re-settable wafer 122 to push the locking bar 54 away from the base wafer 120 and re-settable wafer 122 and into the recess 104. However, those of ordinary skill in the art will appreciate from this disclosure that the teeth 166a and 182a may be formed and/or oriented differently from that which is shown and described.

With reference to FIGS. 1 and 2, the locking bar 56 is disposed in the locking bar recess 104 and is employed to inhibit “horizontal” movement of the locking keys 54 to the point where the second engagement portion 182 disengages the first engagement portion 166. In the particular example provided, the locking bar 56 is an elongated member that is disposed adjacent a lateral side 200 of the locking key 54. The locking bar 56 may or may not contact the lateral side 200 of the locking key 54. An end of the locking bar 56 may be tapered (i.e., wedge shaped) to permit the locking bar 56 to push the locking pins 54 out of the recess 104 and toward the base wafers 120 and re-settable wafers 122 when the locking bar 56 is inserted into the recess 104 to thereby effect meshing engagement between the second engagement portion 182 of the locking bar 54 and the first engagement portion 166. Those of ordinary skill in the art will appreciate that an engagement portion with a configuration that is similar to that of the first engagement portion 166 may be included in the attachment portion 136 of the base wafer 120 (e.g., between the pair of spaced apart arms 150). In such embodiments, insertion of the locking bar 56 into the recess 104 will also effect meshing engagement between the second engagement portion 182 of the locking bar 54 and the engagement portion (not specifically shown) of the base wafer 120.

Insertion of a key 18 that is “matched” to the lock cylinder 10 aligns the wafer subassemblies 52 to the plug 50. In the example provided, the key engaging portion 170 of each re-settable wafer 122 contacts an associated bitting 210 so that the wafer subassemblies 52 are moved in a direction generally transverse to the longitudinal axis 12 of the lock cylinder 10. Since the key 18 is matched to the lock cylinder 10, the wafer subassemblies 52 are positioned within the plug 50 and do not extend into the first and second grooves 36, 38 in the lock cylinder body 14 so that the plug assembly 16 may be rotated relative to the lock cylinder body 14.

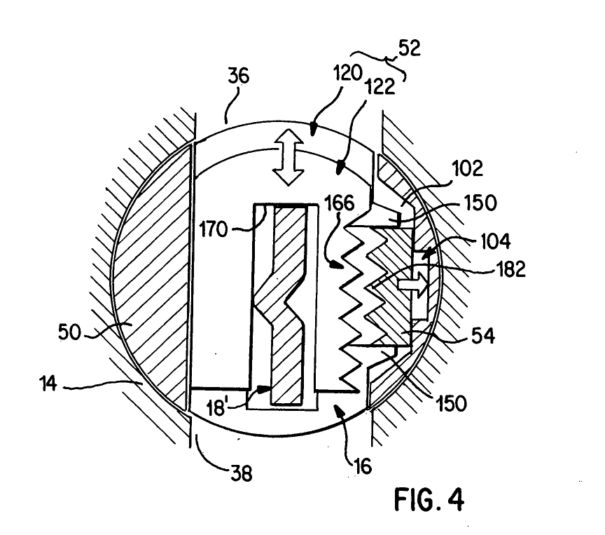

With reference to FIGS. 1 and 4, to re-key the lock cylinder 10, the locking bar 56 is removed and the locking keys 54 are slid outwardly away from the re-settable wafer 122 so as to disengage the first and second engagement portions 166 and 182 from one another. When disengaged, the re-settable wafers 122 are movable relative to the base wafer 120 to which they are abutted in a direction that is generally transverse to the longitudinal axis of the lock cylinder 10. A new key 18′ having a desired bitting configuration is inserted into the plug assembly 16. Contact between the key 18′ and the key engaging portion 170 of the re-settable wafers 122 shifts the re-settable wafers 122 relative to the base wafers 120. The locking keys 54 are then moved toward the re-settable wafers 122 to re-engage the first and second securing portions 166 and 182. The locking bar 56 is replaced to maintain the first and second securing portions 166 and 182 in an engaged condition and thereby “match” the new key 18′ to the lock cylinder 10. While the lock cylinder 10 is illustrated to be in a locked condition during the re-keying process, those of ordinary skill in the art will appreciate from this disclosure that the lock cylinder 10 may be configured to such that the re-keying process may only be initiated when the plug assembly 16 has been rotated out of the locked condition (i.e., such that the wafer assemblies 52 are not directly aligned to the first and second grooves 36 and 38). Significantly, the lock cylinder 10 may be set or programmed directly with a key that is to be used to operate the lock cylinder 10 so that special programming keys are not required.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A lockset comprising:
a lock cylinder body having a wall member, which defines an interior cavity, and first and second grooves formed on an interior surface of the wall member;
a plug assembly with a keyway that is disposed about a longitudinal axis of the plug assembly, the plug assembly including:
a plug having at least one wafer slot, a locking key recess and a locking bar recess, the locking key recess and the locking bar recess extending generally parallel to the longitudinal axis, the locking key recess intersecting the at least one wafer slot and the locking bar recess;
a wafer assembly disposed in each wafer slot, each wafer assembly including a base wafer and a re-settable wafer, each wafer assembly being movable in an associated wafer slot between a first position wherein the wafer assembly extends outwardly from the plug into an associated one of the first and second grooves, and a second position wherein the wafer assembly is substantially retracted into the plug so as to permit the plug to be rotated relative to the lock cylinder body;
a locking key for each wafer assembly, each locking key being disposed in the locking key recess and movable between a first position and a second position, wherein placement of the at least one locking key in the first position couples each base wafer to an associated re-settable wafer so that movement of one of the base wafer and its associated re-settable wafer in a respective wafer slot in a direction that is generally perpendicular to the longitudinal axis effects corresponding movement of the other one of the base wafer and its associated re-settable wafer, wherein placement of the at least one locking key in the second position retracts the locking key from the re-settable wafers so as to permit relative movement that is generally perpendicular to the longitudinal axis between the re-settable wafers and the base wafers; and
a locking bar that is removably disposed in the locking bar recess and wherein placement of the locking bar in the locking bar recess inhibits movement of the at least one locking key from the first position to the second position.

2. The lockset of claim 1, wherein the base wafer includes an attachment portion for inhibiting relative movement of an associated locking key in a direction that is generally transverse to the longitudinal axis.

3. The lockset of claim 2, wherein the attachment portion includes a pair of arms between which the associated locking key is received.

4. The lockset of claim 1, wherein the re-settable wafer includes a plurality of teeth and an associated locking key includes one or more mating teeth that meshingly engage a portion of the teeth on the re-settable wafer when the associated locking key is positioned in the first position.

5. The lockset of claim 4, wherein the base wafer includes a plurality of teeth that meshingly engage the mating teeth of the associated locking key.

6. The lockset of claim 1, wherein the base wafer abuts an axial end face of the re-settable wafer.

7. The lockset of claim 6, wherein the re-settable wafer is generally U-shaped.

8. The lockset of claim 1, wherein the locking bar has a tapered leading edge that urges each of the locking keys into the first position as the locking bar is inserted to the locking bar recess.

9. The lockset of claim 1, wherein each of the wafer assemblies moves in an associated wafer slot in a direction that is generally transverse to the longitudinal axis in response to contact between a profile of a key and an associated re-settable wafer.

10. A method for re-keying a lockset comprising:
providing a lockset having a lock cylinder body and a plug assembly, the plug assembly including a plug body, a plurality of wafer assemblies, a plurality of locking keys, each of the wafer assemblies including a base wafer and a re-settable wafer, each locking key being engaged with an associated wafer assembly to thereby couple the base wafer and the re-settable wafer of each wafer assembly to one another;
inserting a key with a desired key profile into the plug assembly;
disengaging each of the locking keys from an associated re-settable wafer to permit relative movement between each base wafer and its associated re-settable wafer such that at least one of the base wafer and the re-settable wafer contacts the desired key profile; and
re-engaging each of the locking keys to their associated re-settable wafer to inhibit relative movement between the base wafers and the re-settable wafers;
wherein the key is not employed to disengage the locking keys from the associated re-settable wafers.

11. The method of claim 10, wherein the locking keys are disengaged from the associated re-settable wafers while the plug assembly is positioned in a locked condition.

12. The method of claim 10, wherein disengaging the locking keys from the associated re-settable wafers includes removing a locking bar from the plug assembly.

13. The method of claim 12, wherein the locking bar is removed from the plug assembly by withdrawing the locking bar from the plug assembly in a direction that is generally parallel to a longitudinal axis of the plug assembly.

14. Method for re-keying a lockset comprising:
providing a lockset having a lock cylinder body and a plug assembly, the plug assembly including a plug body, a plurality of wafer assemblies, a plurality of locking keys, each of the wafer assemblies including a base wafer and a re-settable wafer, each locking key being engaged with an associated wafer assembly to thereby couple the base wafer and the re-settable wafer of each wafer assembly to one another;
inserting a key with a desired key profile into the plug assembly;
while the plug assembly is in a locked condition, disengaging each of the locking keys from an associated re-settable wafer to permit relative movement between each base wafer and its associated re-settable wafer such that at least one of the base wafer and the re-settable wafer contacts the desired key profile; and
inserting a locking bar into an end of the plug assembly along an axis that is generally parallel to a longitudinal axis of the plug assembly to re-engage each of the locking keys to their associated re-settable wafer to inhibit relative movement between the base wafers and the re-settable wafers.
